(19) United States
(12) Patent Application Publication
(10) Pub. No.: US 2026/0109202 A1
(43) Pub. Date: Apr. 23, 2026

(54) WINDOW REGULATOR

(71) Applicant: Johnan Manufacturing Inc., Ueda-shi (JP)

(72) Inventors: Raku HARADA, Ueda-shi (JP); Hiroyuki NISHI, Ueda-shi (JP)

(73) Assignee: Johnan Manufacturing Inc., Ueda-shi (JP)

(21) Appl. No.: 19/346,655

(22) Filed: Oct. 1, 2025

(30) Foreign Application Priority Data
Oct. 18, 2024 (JP) 2024-184352

(51) Int. Cl. B60J 1/17; E05F 11/48

(52) U.S. Cl. CPC B60J 1/17; E05F 11/483; E05Y 2900/55

(57) ABSTRACT

A window regulator includes a carrier plate that supports a window glass, a guide rail that supports the carrier plate in an ascendable and descendable manner, a wire to pull the carrier plate, and a wire fixing member fixed to an end of the wire. The carrier plate includes a housing portion to house the wire fixing member, a wire lead-out groove to lead the wire from the housing portion to the outside, and a protruding portion that protrudes in a groove width direction from an inner edge of the wire lead-out groove.

### CROSS-REFERENCE TO RELATED APPLICATIONS

The present patent application claims the priority of Japanese patent application No. 2024/184352 filed on Oct. 18, 2024, and the entire contents of Japanese patent application No. 2024/184352 are hereby incorporated by reference.

### TECHNICAL FIELD

The present invention relates to a window regulator.

### BACKGROUND ART

A window regulator is known in which a wire lead-out groove to lead a wire out is curved in an “S” shape (see Patent Literature 1). The window regulator includes a guide rail arranged along a moving direction of a window glass, a carrier plate connected to the window glass, a drum rotationally driven by operation of a motor, a wire connected at one end to the carrier plate and connected at the other end to the drum, a wire end fixed to one end of the wire, and a coil spring to apply tension to the wire end, and the carrier plate has a wire end housing portion to house the wire end and the coil spring, and a wire lead-out groove to lead the wire from the bottom of the wire end housing portion to the outside of the carrier plate. In the window regulator, the wire lead-out groove is curved in an S-shape, thereby suppressing transmission of vibrations from the wire located outside the carrier plate to the wire located inside the wire end housing portion.

### CITATION LIST

### Patent Literatures

Patent Literature 1: JP 2018/066192A

### SUMMARY OF INVENTION

In the known wind regulator, a problem may arise that a wire introduced into a wire lead-out groove may come off the wire lead-out groove.

It is an object of the invention to provide a window regulator that can suppress an event that a wire introduced into a wire lead-out groove comes off the wire lead-out groove.

An aspect of the invention provides a window regulator, comprising:
a. a carrier plate that supports a window glass;
b. a guide rail that supports the carrier plate in an ascendable and descendable manner;
c. a wire to pull the carrier plate; and
d. a wire fixing member fixed to an end of the wire,
e. wherein the carrier plate comprises a housing portion to house the wire fixing member, a wire lead-out groove to lead the wire from the housing portion to the outside, and a protruding portion that protrudes in a groove width direction from an inner edge of the wire lead-out groove.

### ADVANTAGEOUS EFFECTS OF INVENTION

According to an embodiment of the invention, a window regulator can be provided which can suppress the event that the wire introduced into the wire lead-out groove comes off the wire lead-out groove.

### BRIEF DESCRIPTION OF DRAWINGS

FIG. 1 is a general schematic diagram illustrating a window regulator in an embodiment of the present invention and a vehicle door on which the window regulator is provided.

FIG. 2 is a front view showing the window regulator.

FIG. 3 is a partial cross-sectional view showing an area around a carrier plate.

FIG. 4A is a front view showing the carrier plate.

FIG. 4B is a back view showing the carrier plate.

FIG. 4C is a bottom view showing the carrier plate.

FIG. 5 is an enlarged view of a key part showing the carrier plate.

FIG. 6A is a back perspective view showing the carrier plate as viewed from the right side.

FIG. 6B is an enlarged view of a key part showing an area around a first claw portion.

FIG. 7A is a back perspective view showing the carrier plate as viewed from the lower side.

FIG. 7B is an enlarged view of a key part showing an area around a second claw portion.

FIG. 8A is an end view showing an area around the first claw portion when taken along line A-A′ in FIG. 4B.

FIG. 8B is an end view showing an area around the second claw portion when taken along line B-B′ in FIG. 4B.

FIGS. 9A and 9B are first explanatory diagrams illustrating an operation of attaching a descending-side wire.

FIGS. 10A and 10B are second explanatory diagrams illustrating the operation of attaching the descending-side wire.

FIGS. 11A and 11B are third explanatory diagrams illustrating the operation of attaching the descending-side wire.

### DESCRIPTION OF EMBODIMENTS

A window regulator in an embodiment of the invention will be described below with reference to the appended drawings. This window regulator is a raising/lowering device that is installed in a vehicle door provided on a vehicle (e.g., an automobile) and raises/lowers a window glass on the vehicle door. In particular, in this window regulator, a wire lead-out groove to lead a descending-side wire to the outside of the carrier plate has a detachment suppression mechanism to suppress detachment of the descending-side wire from the wire lead-out groove. Hereinafter, an ascending/descending direction of the window glass of the vehicle will be simply referred to as the ascending/descending direction. In addition, left, right, front, rear, up and down used in the following description are as defined in each drawing. In the present embodiment, the ascending/descending direction coincides with the up-down direction of the window regulator, and a vehicle width direction coincides with a front-rear direction of the window regulator. In addition, a direction orthogonal to the ascending/descending direction and the vehicle width direction is a left-right direction of the window regulator.

### (Configuration of the Window Regulator)

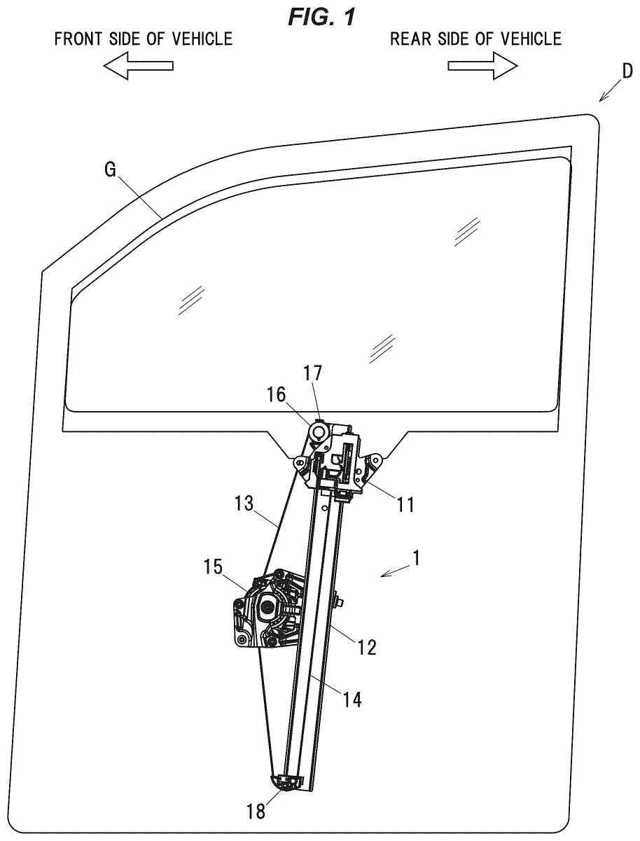

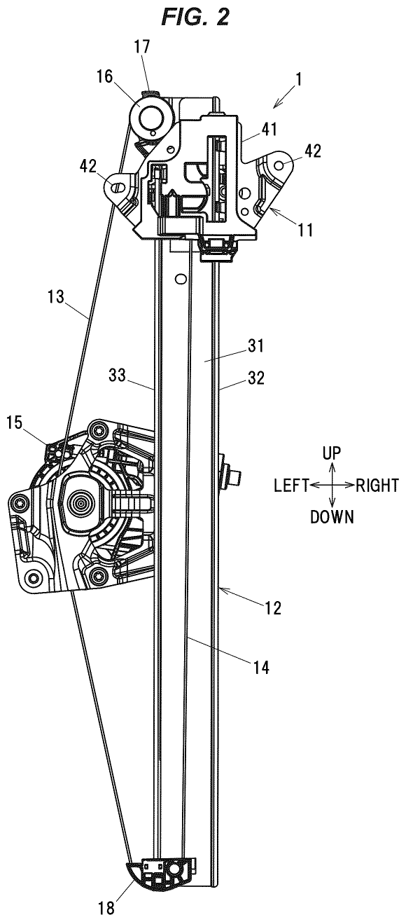

As shown in FIGS. 1 and 2, a window regulator 1 is installed in a vehicle door D and includes a carrier plate 11 that supports a window glass G, a guide rail 12 that supports the carrier plate 11 so as to be slidable in the ascending/descending direction, an ascending-side wire 13 and a descending-side wire 14 that pull the carrier plate 11, a drive unit 15 that is arranged on the guide rail 12 at the center in the up-down direction and drives the ascending-side wire 13 and the descending-side wire 14, a pulley 16 provided at an upper end of the guide rail 12 through a pulley bracket 17 to change the direction of the ascending-side wire 13, and a wire guide 18 provided at a lower end of the guide rail 12 to change the direction of the descending-side wire 14. That is, this window regulator 1 is a wire driving-type window regulator to raise and lower the carrier plate 11 using the wires 13, 14 and is also a banjo-type window regulator having the drive unit 15 arranged on the guide rail 12 at the center in the up-down direction. The ascending-side wire 13 and the descending-side wire 14 are examples of the wire. The ascending-side wire 13, the descending-side wire 14 and the drive unit 15 are an example of a raising/lowering unit to raise and lower the carrier plate 11 along the guide rail 12.

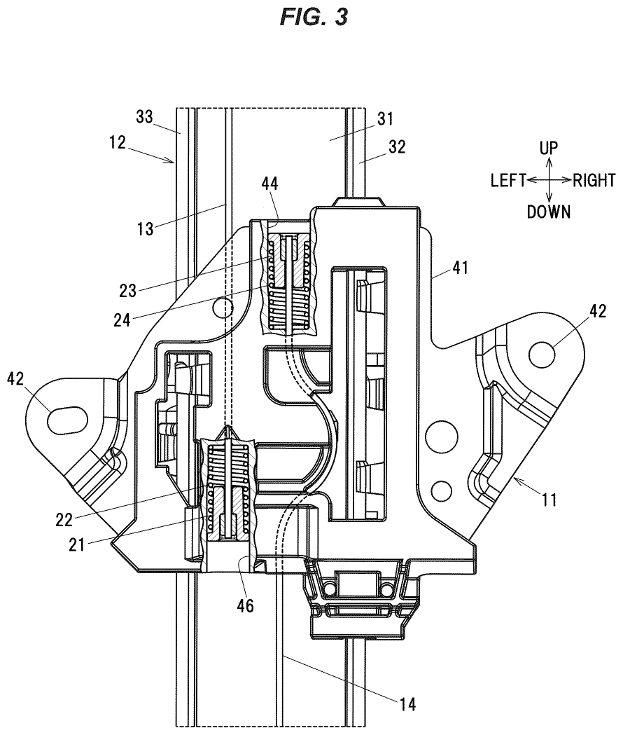

As shown in FIG. 3, the window regulator 1 also includes an ascending-side slide bush 21 fixed to the ascending-side wire 13 at an end on the carrier plate 11 side, an ascending-side spring 22 to apply tension to the ascending-side wire 13 through the ascending-side slide bush 21, a descending-side slide bush 23 fixed to the descending-side wire 14 at an end on the carrier plate 11 side, and a descending-side spring 24 to apply tension to the descending-side wire 14 through the descending-side slide bush 23. The ascending-side slide bush 21 and the descending-side slide bush 23 are examples of the wire fixing member.

As shown in FIG. 1, the guide rail 12 is formed by bending a long metal plate so as to be curved toward the outside of a vehicle cabin at a predetermined curvature, and is arranged so as to tilt to the rear side in a vehicle front-rear direction with respect to the vehicle door D. As shown in FIG. 2, the guide rail 12 integrally has a plate-shaped base portion 31 having a width in the left-right direction and extending in the ascending/descending direction, a right-side plate portion and a left-side plate portion (not shown) that rise toward the front from both ends in the width direction of the base portion 31, a right flange portion 32 protruding to the right from a front end of the right-side plate portion, and a left flange portion 33 protruding to the left from a front end of the left-side plate portion.

The ascending-side wire 13 is connected at one end to a rotating drum (not shown) of the drive unit 15, is fed toward upper right from the drive unit 15 to the pulley 16, is redirected downward by the pulley 16, and is then attached at the other end to the ascending-side slide bush 21 in the carrier plate 11. The ascending-side wire 14 is connected at one end to the rotating drum of the drive unit 15, is fed toward lower right from the drive unit 15 to the wire guide 18, is redirected upward by the wire guide 18, and is then attached at the other end to the descending-side slide bush 23 in the carrier plate 11.

The drive unit 15 is attached to the guide rail 12 at the middle in the up-down direction, has a drive motor, a reducer and the rotating drum, and drives the ascending-side wire 13 and the descending-side wire 14. In particular, when the drive motor of the drive unit 15 rotates forward, the rotating drum rotates forward, and accordingly, the ascending-side wire 13 is taken up onto the rotating drum while the descending-side wire 14 is fed out from the rotating drum. Thus, the carrier plate 11 is pulled by the ascending-side wire 13 and moves upward in the ascending/descending direction. As a result, the window glass G attached to the carrier plate 11 is raised. On the other hand, when the drive motor of the drive unit 15 rotates reverse, the rotating drum rotates reverse, and accordingly, the descending-side wire 14 is taken up onto the rotating drum while the ascending-side wire 13 is fed out from the rotating drum. Thus, the carrier plate 11 is pulled by the descending-side wire 14 and moves downward in the ascending/descending direction. As a result, the window glass G attached to the carrier plate 11 is lowered. In this manner, the carrier plate 11 and the window glass G are raised and lowered along the guide rail 12 (operations of raising and lowering the window glass G).

### (Configuration of the Carrier Plate)

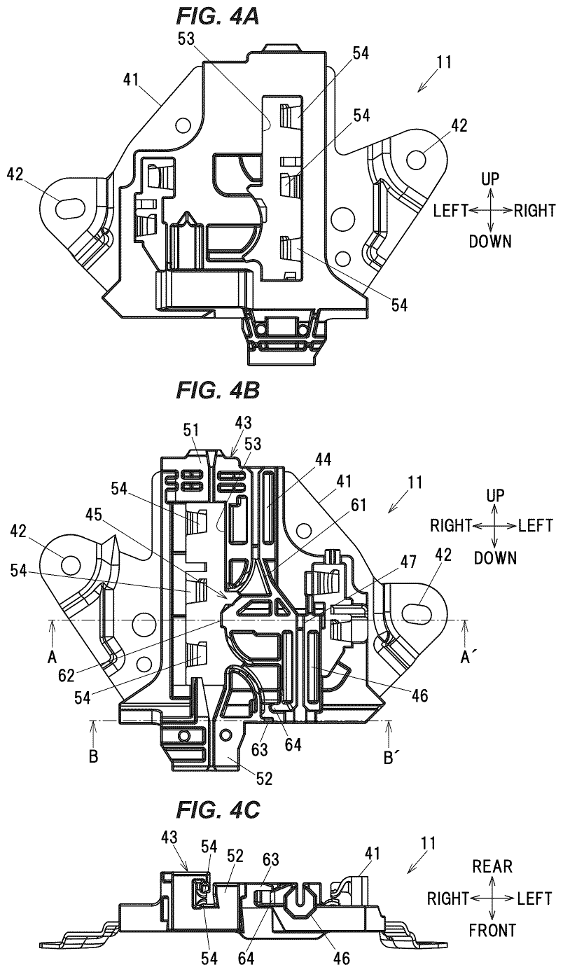

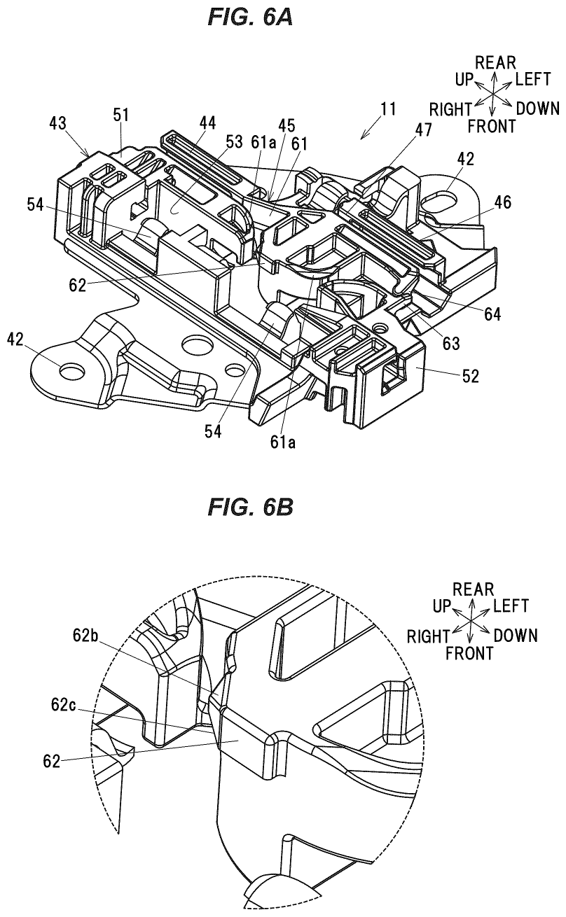

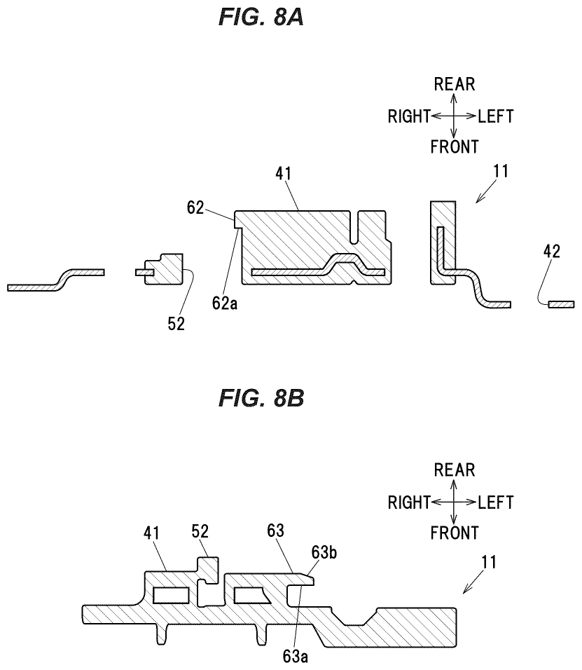

Next, the carrier plate 11 will be described with reference to FIGS. 3 to 8B. As shown in FIGS. 3 to 4C, the carrier plate 11 is formed of a resin and a metal plate integrated by insert molding, and has a plate-shaped main body 41, two attachment holes 42, 42 formed at right and left end portions of the main body 41, a rail attachment portion 43 formed slightly right of the center of the main body 41, a descending-side housing portion 44 formed on the left side of the rail attachment portion 43 and housing the descending-side slide bush 23 and the descending-side spring 24, a descending-side wire lead-out portion 45 formed below the descending-side housing portion 44 and leading the descending-side wire 14 out of the descending-side housing portion 44, an ascending-side housing portion 46 formed on the left side of the descending-side wire lead-out portion 45 and housing the ascending-side slide bush 21 and the ascending-side spring 22, and an ascending-side wire lead-out portion 47 formed above the ascending-side housing portion 46 and leading the ascending-side wire 13 out of the ascending-side housing portion 46. The descending-side housing portion 44 and the ascending-side housing portion 46 are examples of the housing portion.

The attachment holes 42, 42 are for bolting glass holders (not shown) that are fixed to the window glass G. The window glass G is attached to the carrier plate 11 through the glass holders by attaching the glass holders to the attachment holes 42, 42.

The rail attachment portion 43 has a pair of upper and lower side-plate sliding portions 51, 52 that are formed on upper and lower end portions of the back surface of the main body 41 and slide against the right-side plate portion of the guide rail 12, a rectangular opening 53 that is open on the main body 41 between the pair of side-plate sliding portions 51 and 52, and plural sliding fins 54, 54, 54 that are arranged on the rectangular opening 53 and slide against the right flange portion 32 of the guide rail 12. The carrier plate 11 is supported on the guide rail 12 by the rail attachment portion 43 so as to be ascendable/descendible.

As shown in FIG. 3, the ascending-side housing portion 46 is formed in a bottomed hole shape having an octagonal prism-shaped hollow portion with a bottom on the upper side, and has an inner surface and a bottom surface. The ascending-side housing portion 46 houses the ascending-side slide bush 21 inside the hollow portion so that the ascending-side slide bush 21 can advance and retreat in the up-down direction. The ascending-side housing portion 46 also houses the ascending-side spring 22 in a compressed state between a flange of the ascending-side slide bush 21 and the bottom surface. The ascending-side spring 22 blocked by the bottom surface downwardly presses the ascending-side slide bush 21 inside the ascending-side housing portion 46, and tension is thereby applied to the ascending-side wire 13 through the ascending-side slide bush 21.

As shown in FIGS. 4A to 4C, the ascending-side wire lead-out portion 47 is formed in a groove shape with an opening on the rear side, and extends upward from the bottom surface of the ascending-side housing portion 46. The ascending-side wire 13 connected to the ascending-side slide bush 21 is led upward from the ascending-side housing portion 46 to the outside of the carrier plate 11 by the ascending-side wire lead-out portion 47.

As shown in FIG. 3, the descending-side housing portion 44 is formed in a bottomed hole shape having an octagonal prism-shaped hollow portion with a bottom on the lower side, and has an inner surface and a bottom surface. The descending-side housing portion 44 houses the descending-side slide bush 23 inside the hollow portion so that the descending-side slide bush 23 can advance and retreat in the up-down direction. The descending-side housing portion 44 also houses the descending-side spring 24 in a compressed state between a flange of the descending-side slide bush 23 and the bottom surface. The descending-side spring 24 blocked by the bottom surface upwardly presses the descending-side slide bush 23 inside the descending-side housing portion 44, and tension is thereby applied to the descending-side wire 14 through the descending-side slide bush 23.

### (Configuration of the Descending-Side Wire Lead-Out Portion)

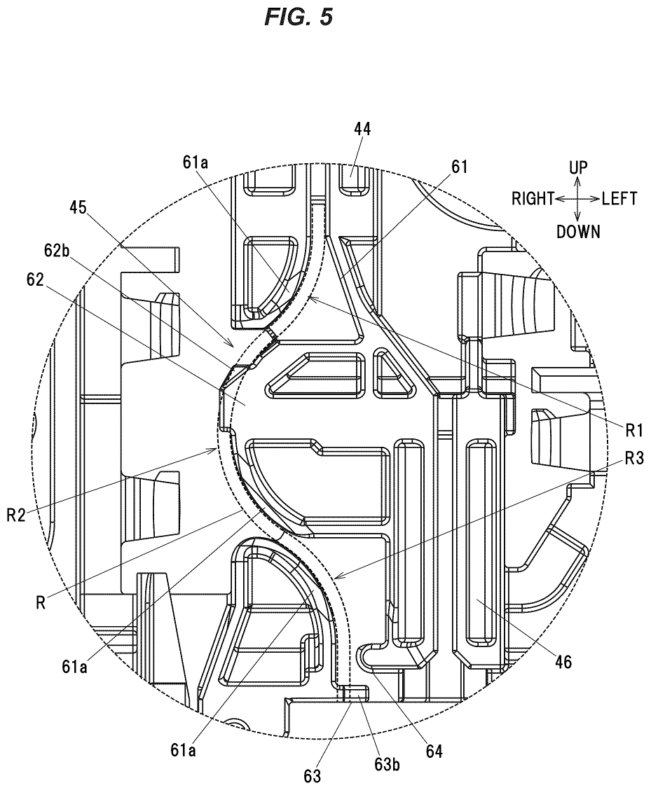

As shown in FIGS. 4A to 5, the descending-side wire lead-out portion 45 has a wire lead-out groove 61 that forms a wire lead-out path R, a first claw portion 62 that is formed at a middle position of the wire lead-out path R and protrudes from a left inner edge of the wire lead-out groove 61, a second claw portion 63 that is formed at a position of an end of the wire lead-out path R and protrudes from a position of an end of the wire lead-out path R, and a restricting protrusion 64 that protrudes from a left wall of the wire lead-out groove 61 just before the position of the end of the wire lead-out path R. The first claw portion 62 and the second claw portion 63 are examples of the protruding portion.

As shown in FIG. 5, the wire lead-out groove 61 forms the wire lead-out path R that serves as a path to lead the descending-side wire 14 from the descending-side housing portion 44 to the outside of the carrier plate 11 (on the lower side of the carrier plate 11) and curves in an arch shape with its peak on the right side. In detail, the wire lead-out path R extends downward from the descending-side housing portion 44, then curves in a downward right direction, then curves in a downward left direction to turn back to the left, and then curves downward. Hereinafter, the portion curved in the downward right direction will be referred to as the first curved portion R1, the portion curved in the downward left direction to turn back to the left will be referred to as the second curved portion R2, and the portion curved downward will be referred to as the third curved portion R3. The first curved portion R1, the second curved portion R2 and the third curved portion R3 are examples of the curved portion.

Then, as shown in FIGS. 5 to 7B, the wire lead-out groove 61 is formed in the shape of a groove with an opening on the rear side, and is provided along the wire lead-out path R from the bottom surface of the descending-side housing portion 44. The wire lead-out groove 61 has a shape in which the groove width is widened at the positions of the first curved portion R1 and the third curved portion R3. Furthermore, the shape of the wire lead-out groove 61 is such that, at the position of the second curved portion R2, the wire lead-out groove 61 faces the rectangular opening 53 and the groove bottom and the right wall are omitted. Moreover, the shape of the wire lead-out groove 61 is such that the left wall is omitted at the position of the end of the wire lead-out path R.

In addition, inclined surfaces 61a, 61a, 61a, which are inclined inward in the groove width direction of the wire lead-out groove 61 so as to be downslope toward the front side (toward the groove bottom of the wire lead-out groove 61), are formed on a right inner edge (an upper end portion of the right wall) of the wire lead-out groove 61 at the position of the first curved portion R1, on a left inner edge (an upper end portion of the left wall) at the position of a lower half of the second curved portion R2, and on the right inner edge (the upper end portion of the right wall) at the position of the third curved portion R3. These inclined surfaces make it easier to introduce the descending-side wire 14 into the wire lead-out groove 61 even at the positions of the first curved portion R1, the second curved portion R2, and the third curved portion R3.

As shown in FIGS. 5, 6A, 6B and 8A, the first claw portion 62 is arranged to extend over the wire lead-out path R at the position of the second curved portion R2, and is formed on the opening side of the wire lead-out groove 61 so as to protrude inward in the groove width direction from the left inner edge (the upper end portion of the left wall) of the wire lead-out groove 61. In addition, a front surface 62a of the first claw portion 62 serves as a locking surface that locks the descending-side wire 14 from the rear side, and the front surface 62a comes into contact with the rear side of the descending-side wire 14 introduced into the wire lead-out groove 61 and locks the descending-side wire 14 in the front-rear direction. This prevents the descending-side wire 14 from being detached rearward (on the rear side in the groove depth direction of the wire lead-out groove 61) from the wire lead-out groove 61 at the position of the second curved portion R2.

In addition, a guide slope 62b, which is inclined toward an end of the first claw portion 62 (in the groove width direction) so as to be downslope toward the front side (toward the groove bottom of the wire lead-out groove 61), is formed on an upper end of a rear surface of the first claw portion 62 (a surface on the rear side in the groove depth direction of the wire lead-out groove 61). The descending-side wire 14 comes into contact with the guide slope 62b when introducing the descending-side wire 14 into the wire lead-out groove 61, is thus guided to the end side of the first claw portion 62, and is introduced into the wire lead-out groove 61 while passing around the first claw portion 62.

Furthermore, an inclined surface 62c, which is inclined toward the base end side of the first claw portion 62 so as to be upslope toward the front side, is formed at the upper end of the front surface of the first claw portion 62. The inclined surface 62c allows the descending-side wire 14, which is guided to the end side of the first claw portion 62 by the guide slope 62b, to easily move onto the wire lead-out path R which is located on the base side of the first claw portion 62.

As shown in FIGS. 5, 7A, 7B and 8B, the second claw portion 63 is arranged to extend over the wire lead-out path R at the position of the end of the wire lead-out path R, and is formed on the opening side of the wire lead-out groove 61 so as to protrude inward in the groove width direction (in the leftward direction) from the right inner edge (the upper end portion of the right wall) of the wire lead-out groove 61. In addition, a front surface 63a of the second claw portion 63 serves as a locking surface that locks the descending-side wire 14 from the rear side, and the front surface 63a comes into contact with the rear side of the descending-side wire 14 introduced into the wire lead-out groove 61 and locks the descending-side wire 14 in the front-rear direction. This prevents the descending-side wire 14 from being detached rearward (on the rear side in the groove depth direction of the wire lead-out groove 61) from the wire lead-out groove 61 at the position of the end of the wire lead-out path R.

In addition, a guide slope 63b, which is inclined toward an end of the second claw portion 63 (in the groove width direction) so as to be downslope toward the front side (toward the groove bottom of the wire lead-out groove 61), is formed on the entire region of the rear surface of the second claw portion 63 (a surface on the rear side in the groove depth direction of the wire lead-out groove 61). The descending-side wire 14 comes into contact with the guide slope 63b when introducing the descending-side wire 14 into the wire lead-out groove 61, is thus guided to the end side of the first claw portion 62, and is introduced into the wire lead-out groove 61 while passing around the second claw portion 63.

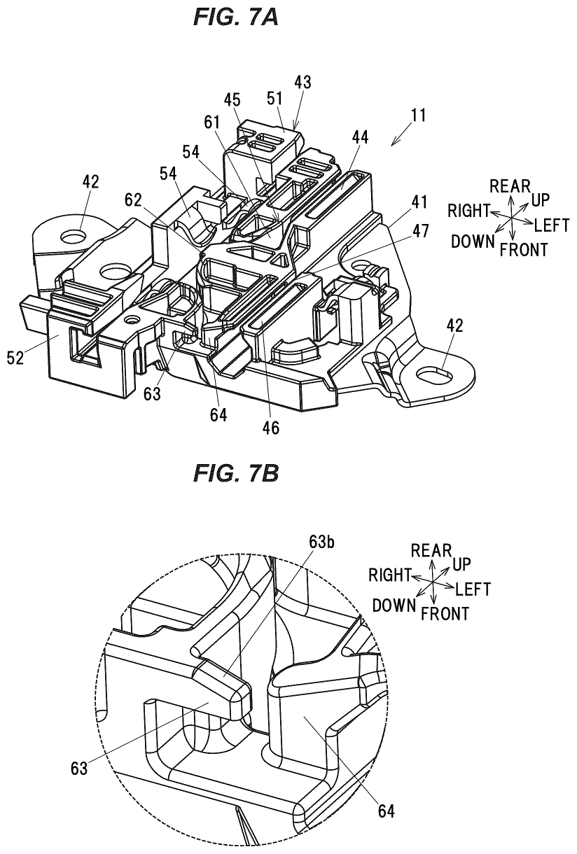

As shown in FIGS. 5 and 7A, the restricting protrusion 64 is formed at a position just before the end of the wire lead-out groove 61 so as to protrude rightward from the left wall of the wire lead-out groove 61, and restricts the movement of the descending-side wire 14 to the left by coming into contract with the left side of the descending-side wire 14. This restricting protrusion 64 restricts the movement of the descending-side wire 14 introduced into the wire lead-out groove 61 toward the side where the end of the second claw portion 63 is located, thereby preventing the descending-side wire 14 introduced into the wire lead-out groove 61 from passing around the end of the second claw portion 63 and coming off the wire lead-out groove 61. Particularly in a state before tension is applied to the descending-side wire 14 during assembly of the window regulator 1, the descending-side wire 14 is prevented from passing around the end of the second claw portion 63 and coming out of the wire lead-out groove 61.

### (Description of a Descending-Side Wire Attachment Operation)

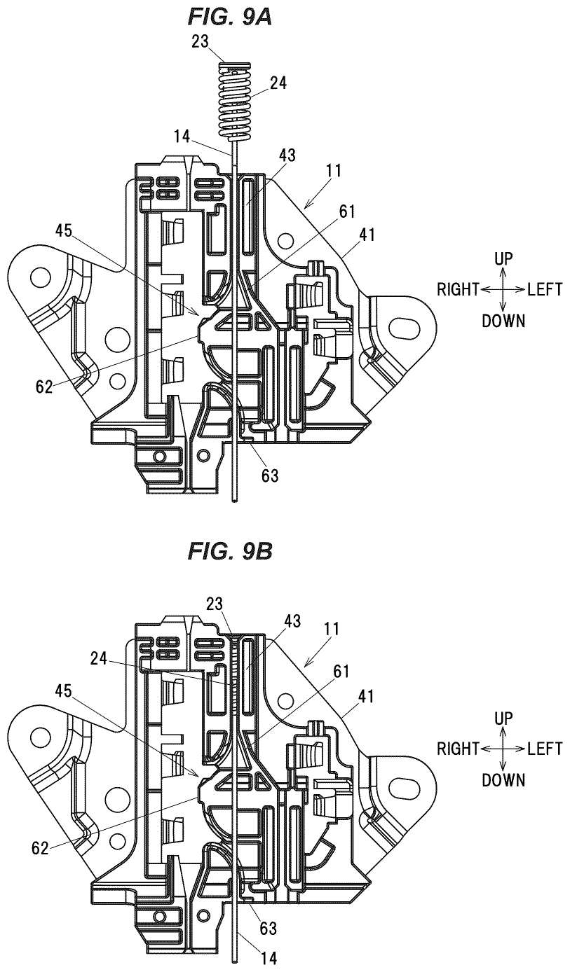

Here, a descending-side wire attachment operation of attaching the descending-side wire 14 to the carrier plate 11 will be described with reference to FIG. 9A to 11B. This descending-side wire attachment operation is performed by housing the descending-side slide bush 23 and the descending-side spring 24 in the descending-side housing portion 44 and introducing the descending-side wire 14 into the wire lead-out groove 61.

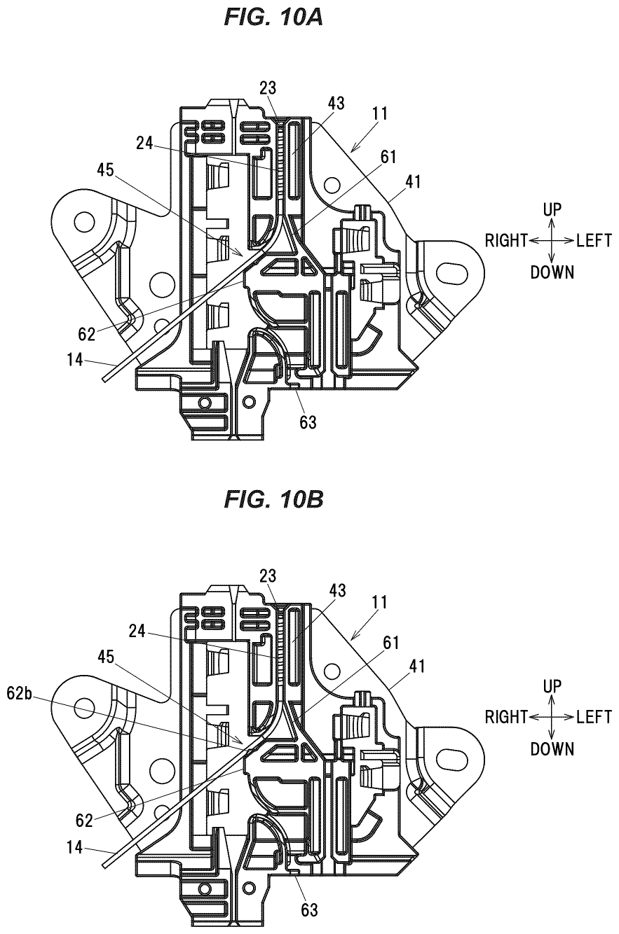

In the descending-side wire attachment operation, first, the descending-side slide bush 23 and the descending-side spring 24 are housed in the descending-side housing portion 44, as shown in FIG. 9B. After placing the descending-side slide bush 23 and the descending-side spring 24 in the descending-side housing portion 44, the descending-side wire 14 is routed along the right wall of the wire lead-out groove 61 at the first curved portion R1 as shown in FIG. 10A, and then, the leading end of the descending-side wire 14 is held and pulled in a downward right direction while being pressed against the wire lead-out groove 61 as shown in FIG. 10B, thereby introducing the descending-side wire 14 into the wire lead-out groove 61. At this time, the descending-side wire 14 comes into contact with the guide slope 62b of the first claw portion 62, which causes the descending-side wire 14 to be guided to the end side of the first claw portion 62, to pass around the first claw portion 62, and to be introduced into the wire lead-out groove 61. As a result, the descending-side wire 14 is introduced under the first claw portion 62, and detachment of the descending-side wire 14 from the wire lead-out groove 61 is suppressed at the position of the second curved portion R2.

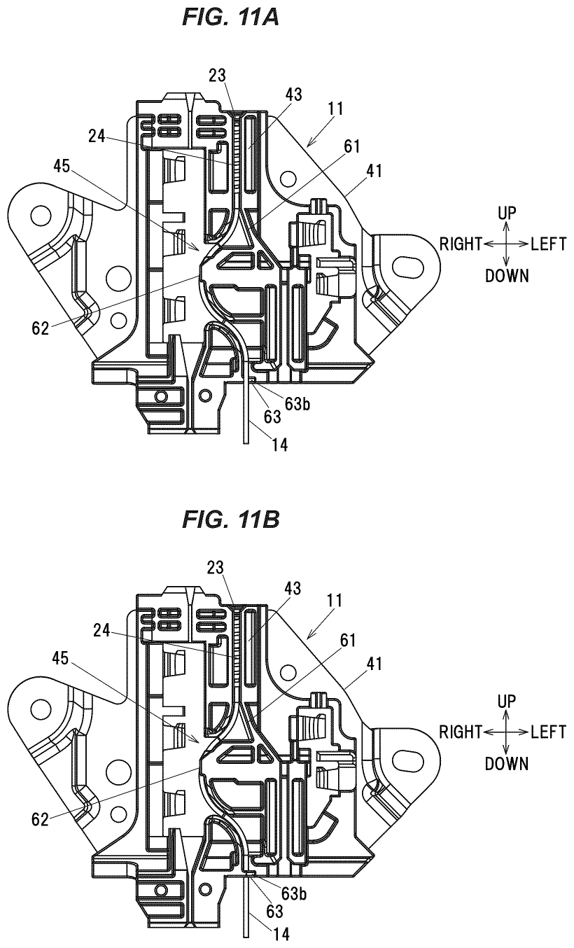

Then, after routing the descending-side wire 14 along the left wall of the wire lead-out groove 61 at the second curved portion R2 and then along the right wall of the wire lead-out groove 61 at the third curved portion R3 as shown in FIG. 11A, the leading end of the descending-side wire 14 is held and pulled downward while being pressed against the wire lead-out groove 61 as shown in FIG. 11B, thereby introducing the descending-side wire 14 into the wire lead-out groove 61. At this time, the descending-side wire 14 comes into contact with the guide slope 63b of the second claw portion 63, which causes the descending-side wire 14 to be guided to the end side of the second claw portion 63, to pass around the second claw portion 63, and to be introduced into the wire lead-out groove 61. As a result, the descending-side wire 14 is introduced under the second claw portion 63, and detachment of the descending-side wire 14 from the wire lead-out groove 61 is suppressed at the position of the end of the wire lead-out path R. The descending-side wire attachment operation then ends.

### (Functions and Effects of the Embodiment)

As described above, according to the configuration of the above embodiment, since the claw portions 62, 63 protruding from the inner edge of the wire lead-out groove 61 are provided, the descending-side wire 14 introduced into the wire lead-out groove 61 is locked in the front-rear direction (in the groove depth direction) by the claw portions 62, 63, hence, it is possible to suppress an event that the descending-side wire 14 introduced into the wire lead-out groove 61 comes off the wire lead-out groove 61. The event that the descending-side wire 14 introduced into the wire lead-out groove 61 comes off the wire lead-out groove 61 can be suppressed particularly in the state before tension is applied to the descending-side wire 14 during assembly of the window regulator 1, hence, the window regulator 1 can be easily assembled. In addition, by arranging the second claw portion 63 at the position of the end of the wire lead-out path R (the position of the end of the wire lead-out groove 61), it is possible to suppress an event that the descending-side wire 14 introduced into the wire lead-out groove 61 comes off the wire lead-out groove 61 during operations of raising and lowering the window glass G. Therefore, troubles in the raising and lowering operations caused by detachment of the descending-side wire 14 from the wire lead-out groove 61 can be suppressed.

In addition, since the wire lead-out groove 61 which forms the curved wire lead-out path R is adopted, sliding resistance between the wire lead-out groove 61 and the descending-side wire 14 occurs at the positions of the curved portions R1, R2, and R3, hence, the sliding resistance between the wire lead-out groove 61 and the descending-side wire 14 can be increased appropriately. This makes it possible to suppress judder (abnormal vibration) of the window glass G during the operations of raising and lowering the window glass G. In this regard, to suppress judder of the window glass G, it is preferable that the sliding resistance value between the wire lead-out groove 61 and the descending-side wire 14 be not less than 3.1 N. That is, in the present embodiment, the wire lead-out groove 61 is formed so that the sliding resistance value between itself and the descending-side wire 14 during the operations of raising and lowering the window glass G is not less than 3.1 N

In addition, in the configuration that employs the wire lead-out groove 61 forming the curved wire lead-out path R, by arranging the second claw portion 63 at the position of the end of the wire lead-out path R, it is possible to suppress the event that the descending-side wire 14 introduced into the wire lead-out groove 61 comes off the wire lead-out groove 61 during the operations of raising and lowering the window glass G. Therefore, the situation in which the judder suppression effect by sliding between the wire lead-out groove 61 and the descending-side wire 14 cannot be obtained due to the descending-side wire 14 coming off the wire lead-out groove 61 during the operations of raising and lowering the window glass G can be avoided as much as possible, and occurrence of judder during the operations of raising and lowering the window glass G can be suppressed.

In addition, the inclined surfaces 61a formed on the inner edge of the wire lead-out groove 61 at the positions of the curved portions R1, R2, and R3 make it possible to easily introduce the descending-side wire 14 into the wire lead-out groove 61 at the positions of the curved portions R1, R2, and R3.

Furthermore, by providing the guide slopes 62b, 63b on the rear surfaces of the claw portions 62, 63, the descending-side wire 14 can be easily introduced under the claw portions 62, 63.

### OTHER EMBODIMENTS

Although the embodiment of the invention has been described, the invention according to claims is not to be limited to the embodiment described above. Further, please note that not all combinations of the features described in the embodiment are necessary to solve the problem of the invention. The invention can be appropriately modified and implemented without departing the gist thereof.

For example, the configuration in the above embodiment is such that the first claw portion 62 and the second claw portion 63 are included, but the configuration may be such that only one of the first claw portion 62 and the second claw portion 63 is included. In addition, the configuration may be such that the claw portions 62 and 63 are arranged at the positions of the first curved portion R1 and the third curved portion R3.

In addition, the configuration in the above embodiment is such that the wire lead-out groove 61 forms a curved wire lead-out path R, but the configuration may be such that the wire lead-out groove 61 forms a straight wire lead-out path R. That is, the invention may be applied to the descending-side wire lead-out portion 45 that employs a wire lead-out groove 61 that forms a straight wire lead-out path R.

In addition, the invention is applied to the descending-side wire lead-out portion 45 in the above embodiment, but the invention may be applied to the ascending-side wire lead-out portion 47. That is, the configuration may be such that the ascending-side wire lead-out portion 47 has the claw portions 62, 63.

In addition, in the above embodiment, the invention is applied to a banjo-type window regulator having the drive unit 15 arranged on the guide rail 12 at the center in the up-down direction, but it is not limited thereto as long as the window regulator is of a wire driving type. For example, the invention may be applied to a lower end drive-type window regulator having the drive unit 15 arranged at a lower end of the guide rail 12, or the invention may be applied to a window regulator with the drive unit 15 fixed directly to (a door panel of) the vehicle door D (such as a delta-type window regulator).

### SUMMARY OF THE EMBODIMENTS

Technical ideas understood from the embodiments will be described below citing the reference signs, etc. used for the embodiments. However, each reference sign, etc. described below is not intended to limit the constituent elements in the claims to the members, etc., specifically described in the embodiments.

(a) A window regulator (1) comprising: a carrier plate (11) that supports a window glass (G); a guide rail (12) that supports the carrier plate (11) in an ascendable and descendable manner; a wire (14) to pull the carrier plate (11); and a wire fixing member (23) fixed to an end of the wire (14), wherein the carrier plate (11) comprises a housing portion (44) to house the wire fixing member (23), a wire lead-out groove (61) to lead the wire (14) from the housing portion (44) to the outside, and a protruding portion (52, 53) that protrudes in a groove width direction from an inner edge of the wire lead-out groove (61) on the opening side of the wire lead-out groove (61).
(b) The window regulator (1) defined in (a), wherein the wire lead-out groove (61) forms a wire lead-out path (R) comprising a curved portion (R1, R2, R3).
(c) The window regulator (1) defined in (b), wherein the wire lead-out groove (61) forms a wire lead-out path (R), and the protruding portion (52, 53) is arranged at a position of an end of the wire lead-out path (R).
(d) The window regulator (1) defined in (b), wherein the protruding portion (52, 53) is arranged at a position of the curved portion (R2).
(e) The window regulator (1) defined in any one of (a) to (d), wherein an inclined surface (61a), which is inclined inward in the groove width direction of the wire lead-out groove (61) so as to be downslope toward a groove bottom of the wire lead-out groove (61), is formed on an inner edge of the wire lead-out groove (61) at the position of the curved portion (R1, R2, R3).
(f) The window regulator (1) defined in any one of (a) to (e), wherein a guide slope (62b, 63b), which is inclined toward an end of the protruding portion (52, 53) so as to be downslope toward the groove bottom of the wire lead-out groove (61), is formed on a surface of the protruding portion (52, 53) on a rear side in a groove depth direction of the wire lead-out groove (61).

### REFERENCE SIGNS LIST

1 WINDOW REGULATOR
11 CARRIER PLATE
12 GUIDE RAIL
14 DESCENDING-SIDE WIRE
23 DESCENDING-SIDE SLIDE BUSH
44 DESCENDING-SIDE HOUSING
61 WIRE LEAD-OUT GROOVE
62 FIRST CLAW PORTION
62b GUIDE SLOPE
63 SECOND CLAW PORTION
63b GUIDE SLOPE
R WIRE LEAD-OUT PATH
R1 FIRST CURVED PORTION
R2 SECOND CURVED PORTION
G WINDOW GLASS
R3 THIRD CURVED PORTION

1. A window regulator, comprising:
a carrier plate that supports a window glass;
a guide rail that supports the carrier plate in an ascendable and descendable manner;
a wire to pull the carrier plate; and
a wire fixing member fixed to an end of the wire,
wherein the carrier plate comprises a housing portion to house the wire fixing member, a wire lead-out groove to lead the wire from the housing portion to the outside, and a protruding portion that protrudes in a groove width direction from an inner edge of the wire lead-out groove.

2. The window regulator according to claim 1, wherein the wire lead-out groove forms a wire lead-out path comprising a curved portion.

3. The window regulator according to claim 2, wherein the protruding portion is arranged at a position of an end of the wire lead-out path.

4. The window regulator according to claim 2, wherein the protruding portion is arranged at a position of the curved portion.

5. The window regulator according to claim 2, wherein an inclined surface, which is inclined inward in the groove width direction of the wire lead-out groove so as to be downslope toward a groove bottom of the wire lead-out groove, is formed on an inner edge of the wire lead-out groove at the position of the curved portion.

6. The window regulator according to claim 1, wherein a guide slope, which is inclined toward an end of the protruding portion so as to be downslope toward the groove bottom of the wire lead-out groove, is formed on a surface of the protruding portion on a rear side in a groove depth direction of the wire lead-out groove.
